(19) United States
(12) Patent Application Publication
(10) Pub. No.: US 2017/0049258 A1
(43) Pub. Date: Feb. 23, 2017

(54) PROPORTION-INTEGRATION-DERIVATION (PID) KETTLE STRUCTURE

(71) Applicant: Xiamen Runner Industrial Corporation, Xiamen (CN)

(72) Inventors: Shao-wei Yang, Xiamen (CN); Yun-chuan Wang, Xiamen (CN); Tian-ming Xie, Xiamen (CN)

(21) Appl. No.: 15/220,133

(22) Filed: Jul. 26, 2016

(30) Foreign Application Priority Data
Aug. 18, 2015 (CN) 201520618601.9

(51) Int. Cl. A47J 27/212; B01D 35/143; A47J 27/21; C02F 1/00

(52) U.S. Cl. CPC A47J 27/212; C02F 1/003; B01D 35/143; A47J 27/21183; A47J 27/21175; C02F 2307/04

(57) ABSTRACT

A proportion-integration-derivation (PID) kettle structure includes: a kettle upper cover; a water filling cap, embedded into kettle upper cover; and a PID element, fixed onto inner side of water filling cap, to indicate usage time of a filter core in a kettle. The PID element includes: a guiding axis, disposed at an end inside the water filling cap; a pushing rack, sleeved around the guiding axis; a reset spring, disposed between pushing rack and guiding axis; an arc-shape rack pushing boss, disposed symmetrically on both sides of the pushing rack, used to push the pushing rack to move, when water filling cap is opened or closed; a driving gear, disposed at front end of the pushing rack, to act in cooperation with the pushing rack; and a driven gear, disposed below the driving gear, and connected to rotate along with the driving gear.

### BACKGROUND OF THE INVENTION

Field of the Invention

The present invention relates to a kettle structure, and in particular to a proportion-integration-derivation (PID) kettle structure.

The Prior Arts

In recent years, people are paying increasing attention to the hygiene of drinking water. In this respect, water kettles are usually provided with filtering device, such as filtering core, to filter and purify water for safe drinking. However, after long period of usage, the filtering core tends to accumulate large amount of dust and germs, to lose its water purifying capability. In general, in application, users tend to neglect if the filter core has exceeded its effective service life. Meanwhile, the existing water kettles are not equipped with device indicating the current service time of the filter core.

Therefore, presently, the design and performance of the water kettle is not quite satisfactory, and it leaves much room for improvement.

### SUMMARY OF THE INVENTION

In view of the problems and drawbacks of the prior art, the present invention provides a proportion-integration-derivation (PID) kettle structure, to overcome the shortcomings of the prior art.

The present invention provides a proportion-integration-derivation (PID) kettle structure, comprising: a kettle upper cover; a water filling cap, embedded into kettle upper cover; and a PID element, fixed onto the inner side of the water filling cap, to indicate usage time of a filter core in a kettle.

In an aspect of the present invention, an end of the water filling cap is hinged onto the kettle upper cover.

In another aspect of the present invention, the present invention further includes a shell, covering and surrounding the PID element.

In yet another aspect of the present invention, the PID element includes: a guiding axis, disposed at an end inside the water filling cap; a pushing rack, sleeved around the guiding axis; a reset spring, disposed between the pushing rack and the guiding axis; an arc-shape rack pushing boss, disposed symmetrically on both sides of the pushing rack, used to push the pushing rack to move, when the water filling cap is opened or closed; a driving gear, disposed at front end of the pushing rack, to act in cooperation with the pushing rack; and a driven gear, disposed below the driving gear, and connected to rotate along with the driving gear.

In a further aspect of the present invention, the present invention further includes: a groove, disposed at an end of the shell, to receive the arc-shape rack pushing boss; an U-shaped fastener, to connect an end of the guiding axis with the water filling cap; a protrusion column, disposed at inner side of the water filling cap, such that the driving gear and the driven gear are sleeved around the protrusion column; a coaxial small ring gear, disposed on a gear surface of the driving gear near the driven gear, such that the coaxial small ring gear engages the driven gear; a snap-on cover, disposed at an end of the protrusion column for placing the driving gear; a stop tooth, disposed at inner surface of the water filling cap located symmetrically on both sides of the driving gear; and an opening, disposed on the shell opposite the driving gear, such that the arc-shape rack pushing boss and the kettle upper cover form into a body.

In an aspect of the present invention, the present invention further includes: a viewing window, disposed on the water filling cap and near a gear surface of the driven gear; and a rating plate, disposed on the gear surface of the driven gear near an inner side of the water filling cap.

In another aspect of the present invention, on the rating plate is provided with calibrations indicating usage time of a filtering core.

In yet another aspect of the present invention, the pushing rack includes: a guiding rod, disposed slantwise; and a hook portion, disposed beside the guiding rod, and is used to bring the driving gear into rotation, when the pushing rack moves forward, while the hook portion is provided with hook teeth engaging the driving gear.

In a further aspect of the present invention, the present invention further includes a guiding plate, disposed on an inner side of the water filling cap, and used to guide the guiding rod.

In yet another aspect of the present invention, the present invention further includes: a stop slot, disposed on a gear surface of the driving gear, close to an inner side of the water filling cap, to prevent reverse rotation of the driving gear, so that the stop slot acts in cooperation with the stop tooth; and a restoration poking handle, disposed on the driving gear.

Compared with the Prior Art, the present invention has the advantages that, it is simple in construction, and it is capable of indicating the usage time of the filter core.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a proportion-integration-derivation (PID) kettle structure having its shell removed according to an embodiment of the present invention;

FIG. 2 is a cross section view of a proportion-integration-derivation (PID) kettle structure having its shell removed according to an embodiment of the present invention;

FIG. 3 is an exploded view of a proportion-integration-derivation (PID) kettle structure according to an embodiment of the present invention;

FIG. 4 is a schematic diagram of a pushing rack according to an embodiment of the present invention;

FIG. 5 is a schematic diagram of a water filling cap according to an embodiment of the present invention according to an embodiment of the present invention;

FIG. 6 is a schematic diagram of a driver gear according to an embodiment of the present invention;

FIG. 7 is a schematic diagram of a kettle upper cover according to an embodiment of the present invention; and

FIG. 8 is a schematic diagram of a kettle having installed a proportion-integration-derivation (PID) kettle structure according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

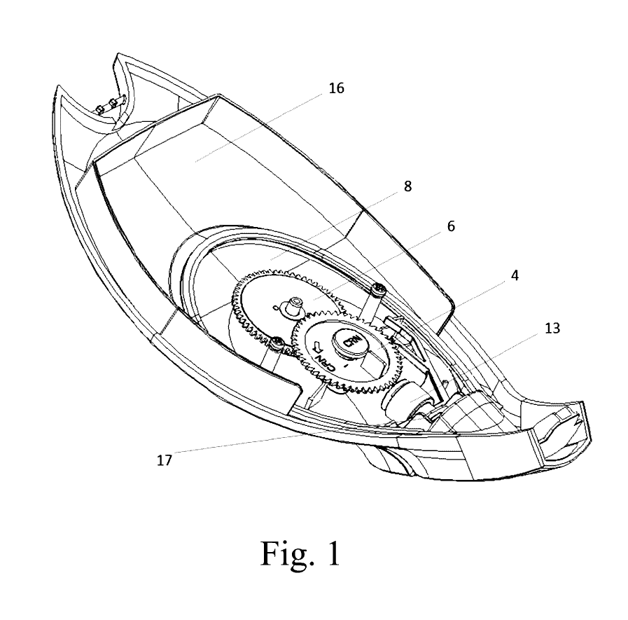

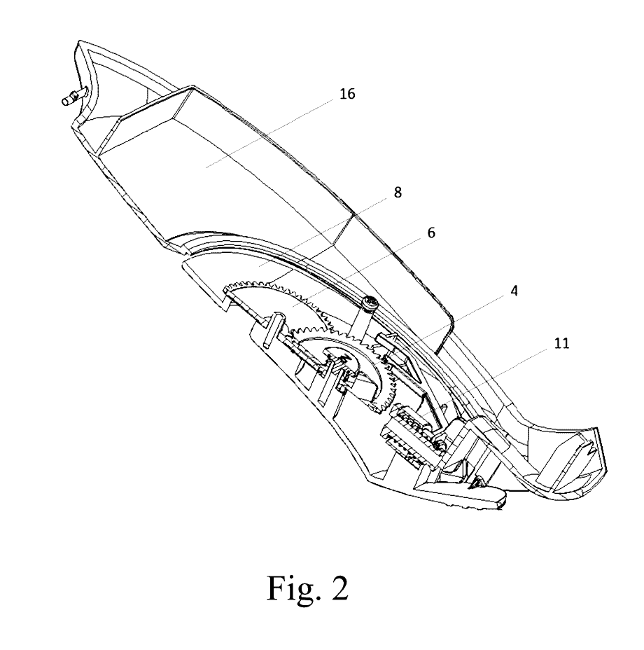

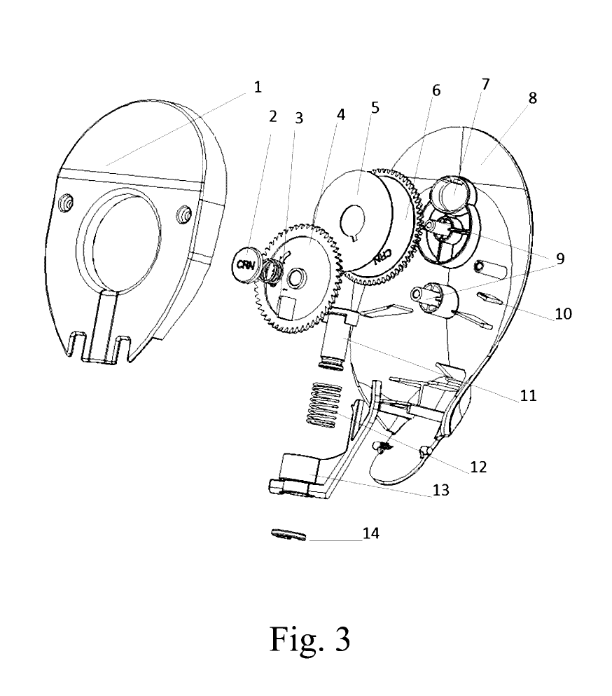

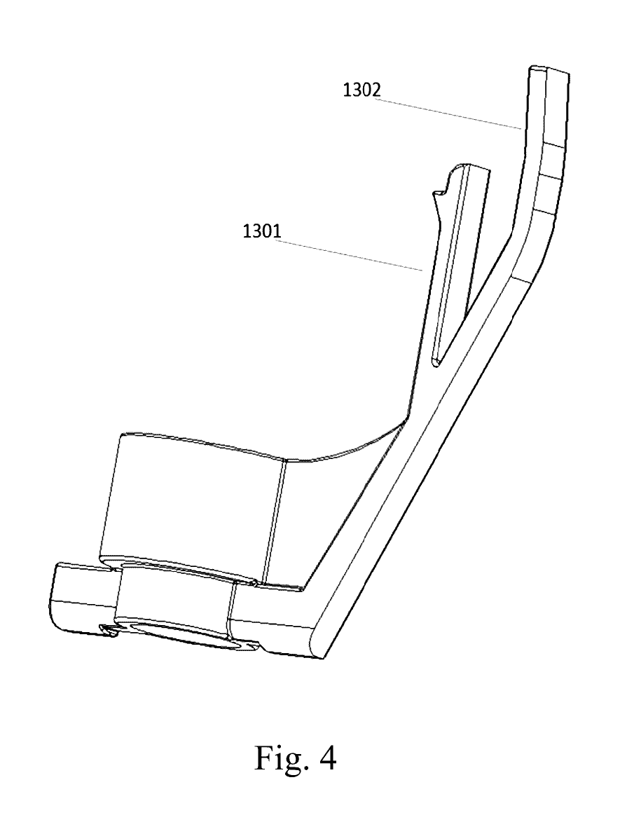

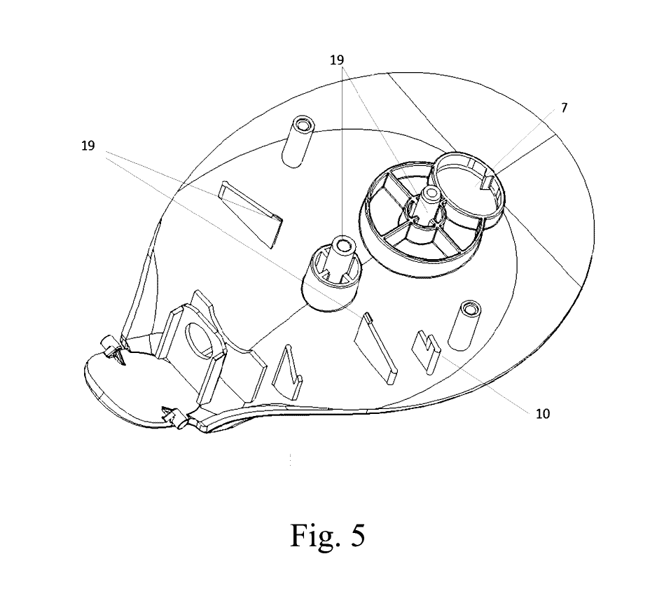

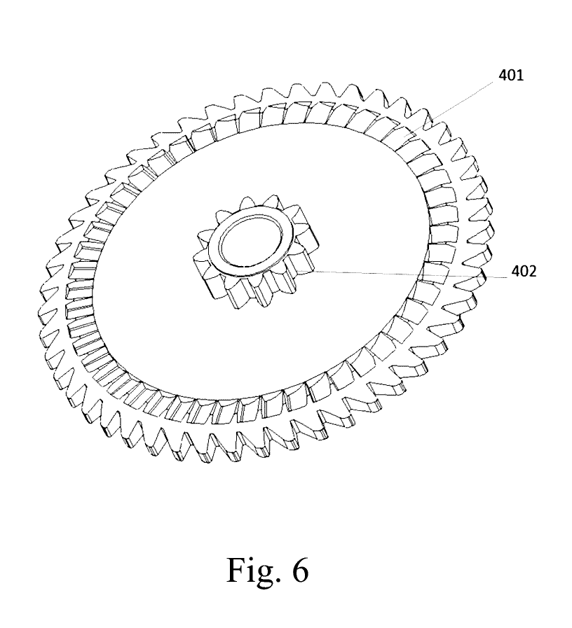

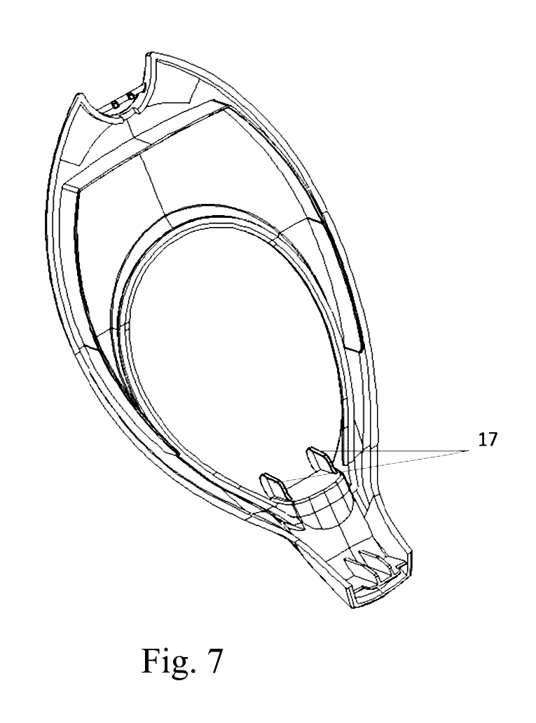

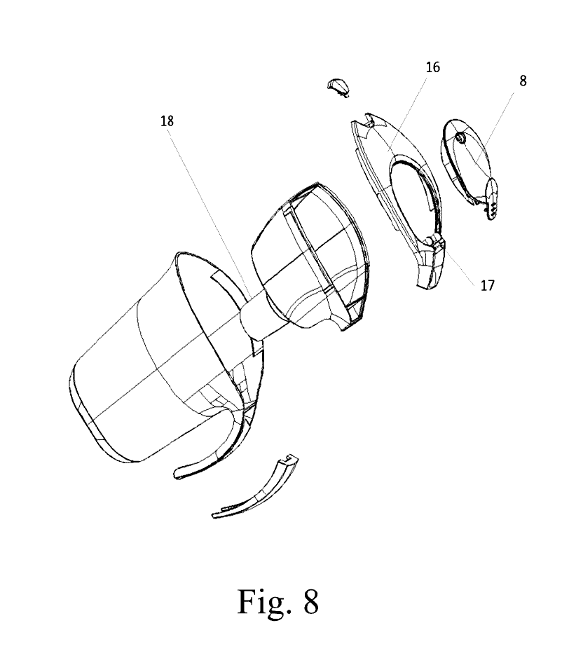

Refer to FIGS. 1 to 8 respectively for a schematic diagram of a proportion-integration-derivation (PID) kettle structure having its shell removed according to an embodiment of the present invention; a cross section view of a proportion-integration-derivation (PID) kettle structure having its shell removed according to an embodiment of the present invention; an exploded view of a proportion-integration-derivation (PID) kettle structure according to an embodiment of the present invention; a schematic diagram of a pushing rack according to an embodiment of the present invention; a schematic diagram of a water filling cap according to an embodiment of the present invention according to an embodiment of the present invention; a schematic diagram of a driver gear according to an embodiment of the present invention; a schematic diagram of a kettle upper cover according to an embodiment of the present invention; and a schematic diagram of a kettle having installed a proportion-integration-derivation (PID) kettle structure according to an embodiment of the present invention.

As shown in FIGS. 1 to 8, the present invention provides a proportion-integration-derivation (PID) kettle structure, comprising: a kettle upper cover 16; a water filling cap 8, embedded into kettle upper cover 16; and a PID element, fixed onto the inner side of the water filling cap 8, to indicate usage time of a filter core 18 in a kettle.

In an embodiment of the present invention, an end of the water filling cap 8 is hinged onto the kettle upper cover 16.

In an embodiment of the present invention, the present invention further includes a shell 1, covering and surrounding the PID element.

In an embodiment of the present invention, the PID element includes: a guiding axis 11, disposed at an end inside the water filling cap 8; a pushing rack 13, sleeved around the guiding axis 11; a reset spring, disposed between the pushing rack 13 and the guiding axis 11; an arc-shape rack pushing boss 17, disposed symmetrically on both sides of the pushing rack 13, used to push the pushing rack 13 to move, when the water filling cap 8 is opened or closed; a driving gear 4, disposed at front end of the pushing rack 13, to act in cooperation with the pushing rack 13; and a driven gear 6, disposed below the driving gear 4, and connected to rotate along with the driving gear 4.

In an embodiment of the present invention, the present invention further includes: a groove, disposed at an end of the shell 1, to receive the arc-shape rack pushing boss 17; an U-shaped fastener 14, to connect an end of the guiding axis 11 with the water filling cap 8; a protrusion column 9, disposed at inner side of the water filling cap 8, such that the driving gear 4 and the driven gear 6 are sleeved around the protrusion column 9; a coaxial small ring gear 401, disposed on a gear surface of the driving gear 4 near the driven gear 6, such that the coaxial small ring gear 401 engages the driven gear 6; a snap-on cover 2, disposed at an end of the protrusion column 9 for placing the driving gear 4; a stop tooth 19, disposed at inner surface of the water filling cap 8 located symmetrically on both sides of the driving gear 4; and an opening, disposed on the shell 1 opposite the driving gear 4, such that the arc-shape rack pushing boss 17 and the kettle upper cover 16 form into a body.

In an embodiment of the present invention, the present invention further includes: a viewing window 7, disposed on the water filling cap 8 and near a gear surface of the driven gear 6; and a rating plate 5, disposed on the gear surface of the driven gear 6 near an inner side of the water filling cap 8.

In an embodiment of the present invention, on the rating plate 5 is provided with calibrations indicating usage time of a filtering core 18.

In an embodiment of the present invention, the pushing rack 13 includes: a guiding rod 1302, disposed slantwise; and a hook portion 1301, disposed beside the guiding rod 1302, and used to bring the driving gear 4 into rotation, when the pushing rack 13 moves forward, while the hook portion 1301 is provided with hook teeth engaging the driving gear 4.

In an embodiment of the present invention, the present invention further includes a guiding plate 10, disposed on an inner side of the water filling cap 8, and used to guide the guiding rod 1302.

In an embodiment of the present invention, the present invention further includes: a stop slot 402, disposed on a gear surface of the driving gear 4, close to an inner side of the water filling cap 8, to prevent reverse rotation of the driving gear 4, so that the stop slot 402 acts in cooperation with the stop tooth 19; and a restoration poking handle 3, disposed on the driving gear 4.

The proportion-integration-derivation (PID) kettle structure of the present invention is applicable to various kind of water kettle.

In the following, the operations of the proportion-integration-derivation (PID) kettle structure of the present invention are described in detail.

In operation, firstly, the user has to rotate manually the restoration poking handle 3 counterclockwise, so that the “SET” on the rating plate 5 can be viewed through the viewing window.

In the process of closing down the water filling cap 8, the lateral portion of the pushing rack 13 is made to move along the arc surface of the arc-shape rack pushing boss 17, so that the pushing rack 13 moves forward along the guiding axis 11. In this way, the hook portion 1301 of the pushing rack 13 pushes the driving gear 4 to rotate a tooth. The driving gear 4 brings the driven gear 6 and he rating plate 5 thereon to rotate, meanwhile, the restoration spring 12 is compressed.

In the process of opening up the water filling cap 8, under the action of the compressed restoration spring 12, the pushing rack 13 is restored to its original position., while the hook portion 1301 moves to next tooth of the driving gear 4. In this way, the stop tooth 19 acts in cooperation with the stop slot on the driving gear 4, to prevent the reverse rotation of the driving gear 4.

As such, when the water filling cap 8 opens and closes once, the number on the rating plate 5 will increase by 1, such that the filter core usage calibration of the rating plate 5 on the driven gear 6 indicates the usage time of the filter core 18. When the number on the rating plate 5 turns around 1 cycle to reach “SET”, that indicates the filter core 18 has reached its service life, such that the filter core 18 has to be replaced.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A proportion-integration-derivation (PID) kettle structure, comprising:
a kettle upper cover;
a water filling cap, embedded into kettle upper cover; and
a PID element, fixed onto the inner side of the water filling cap, to indicate usage time of a filter core in a kettle.

2. The proportion-integration-derivation (PID) kettle structure as claimed in claim 1, wherein an end of the water filling cap is hinged onto the kettle upper cover.

3. The proportion-integration-derivation (PID) kettle structure as claimed in claim 1, further comprising: a shell, covering and surrounding the PID element.

4. The proportion-integration-derivation (PID) kettle structure as claimed in claim 1, wherein the PID element includes:
a guiding axis, disposed at an end inside the water filling cap;
a pushing rack, sleeved around the guiding axis;
a reset spring, disposed between the pushing rack and the guiding axis;
an arc-shape rack pushing boss, disposed symmetrically on both sides of the pushing rack, used to push the pushing rack to move, when the water filling cap is opened or closed;
a driving gear, disposed at front end of the pushing rack, to act in cooperation with the pushing rack; and
a driven gear, disposed below the driving gear, and connected to rotate along with the driving gear.

5. The proportion-integration-derivation (PID) kettle structure as claimed in claim 1, further comprising:
a groove, disposed at an end of the shell, to receive the arc-shape rack pushing boss;
an U-shaped fastener, to connect an end of the guiding axis with the water filling cap;
a protrusion column, disposed at inner side of the water filling cap, such that the driving gear and the driven gear are sleeved around the protrusion column;
a coaxial small ring gear, disposed on a gear surface of the driving gear near the driven gear, such that the coaxial small ring gear engages the driven gear;
a snap-on cover, disposed at an end of the protrusion column for placing the driving gear;
a stop tooth, disposed at inner surface of the water filling cap located symmetrically on both sides of the driving gear; and
an opening, disposed on the shell opposite the driving gear, such that the arc-shape rack pushing boss and the kettle upper cover form into a body.

6. The proportion-integration-derivation (PID) kettle structure as claimed in claim 1, further comprising:
a viewing window, disposed on the water filling cap and near a gear surface of the driven gear; and
a rating plate, disposed on the gear surface of the driven gear near an inner side of the water filling cap.

7. The proportion-integration-derivation (PID) kettle structure as claimed in claim 6, wherein on the rating plate is provided with calibrations indicating usage time of a filtering core.

8. The proportion-integration-derivation (PID) kettle structure as claimed in claim 4, wherein the pushing rack includes:
a guiding rod, disposed slantwise; and
a hook portion, disposed beside the guiding rod, and used to bring the driving gear into rotation, when the pushing rack moves forward, while the hook portion is provided with hook teeth for engaging the driving gear.

9. The proportion-integration-derivation (PID) kettle structure as claimed in claim 1, further comprising: a guiding plate, disposed on an inner side of the water filling cap, and used to guide the guiding rod.

10. The proportion-integration-derivation (PID) kettle structure as claimed in claim 1, further comprising:
a stop slot, disposed on a gear surface of the driving gear, close to an inner side of the water filling cap, to prevent reverse rotation of the driving gear, so that the stop slot acts in cooperation with the stop tooth; and
a restoration poking handle, disposed on the driving gear.
